(19) United States
(12) Patent Application Publication
(10) Pub. No.: US 2003/0074514 A1
(43) Pub. Date: Apr. 17, 2003

(54) Interface card for a media card

(76) Inventors: Masato Minami, Sagamihara-shi (JP); Satoshi Sakuragi, Yokohama-shi (JP); Wataru Kakinoki, Yokohama-shi (JP); Shinji Ushigami, Fujisawa-shi (JP)

Correspondence Address: KEATING & BENNETT LLP, Suite 312, 10400 Eaton Place, Fairfax, VA, 22030, US

(21) Appl. No.: 10/253,590

(22) Filed: Sep. 25, 2002

(30) Foreign Application Priority Data
Sep. 26, 2001 (JP) 2001-294355 PAT.

(51) Int. Cl. G06F 13/40

(52) U.S. Cl. 710/307

(57) ABSTRACT

An interface card is connected to a first data bus with a first bit width (for example, 16-bit width) and has a data storage section which is capable of storing data of a second bit width (for example, 32 bits of data) which is larger than the first bit width. Between the data storage section and an information processing device, data transmission is carried out via a second data bus with the second bit width.

### BACKGROUND OF THE INVENTION

1. Field of the Invention

The present invention relates to an interface card for a media card which can be inserted into a slot of an information processing device while holding a media card therein so as to permit data transmission between the information processing device, which may be a personal computer or other processing device, and the media card.

2. Description of Related Art

Interface cards which can be inserted into PC card slots of personal computers while holding media cards therein have been already developed for practical use. The interface cards permit data which were stored in the media cards while being used in digital cameras, digital video cameras, mobile telephones and other such apparatuses to be also used in information processing devices such as personal computers.

In some of these types of media cards and interface cards, as FIG. 8 shows, data transmission between the media card 54 and the interface card 50 is carried out by a data bus with a 16-bit width. In this case, the data transmission mode between the information processing device 52 and the interface card 50 is also set to the transmission mode carried out by the data bus with a 16-bit width. Consequently, data transmission between the information processing device 52 and the media card 54 is carried out completely via data buses with a 16-bit width.

Meanwhile, as a data transmission mode between an information processing device and a PC card, a card bus mode in which a data bus with a 32-bit width is used has been already provided for practical use. As already mentioned, however, when data transmission between a storage medium and an interface card is carried out via a data bus with a 16-bit width, even if the information processing device is compatible with the card bus mode, data transmission will be carried out via data buses with a 16-bit width. Thus, the information processing device cannot utilize its full transmission performance.

Generally, the data transmission speed between a media card and an interface card is faster than the data transmission speed between an information processing device and an interface card. If both data transmission between a media card and an interface card and data transmission between an information processing device and an interface card are carried out via data buses with a 16-bit width, however, the ability of high-speed data transmission between the media card and the interface card cannot be fully used.

### SUMMARY OF THE INVENTION

In order to overcome the problems described above, preferred embodiments of the present invention provide an interface card for a media card which can fully use the respective data processing abilities of an information processing device and a media card, thereby resulting in an increase in data transmission speed.

According to a preferred embodiment of the present invention, an interface card for a media card which is capable of being inserted into and ejected from a card slot of an information processing device while holding a media card therein and which carries out data transmission between the media card and the information processing device includes a data storage section which is capable of storing data sent from the media card, and in the interface card, a mode which is adopted for data transmission between the data storage section and the information processing device and a mode which is adopted for data transmission between the data storage section and the media card are different from each other. In the structure, the mode of data transmission between the interface card and the information processing device does not depend on the mode of data transmission between the interface card and the media card, and higher-speed data transmission between the interface card and the information processing device is possible. Consequently, the speed of data transmission between the information processing device and the media card becomes higher.

Other features, elements, characteristics and advantages of the present invention will become more apparent from the following detailed description of preferred embodiments with reference to the attached drawings.

### BRIEF DESCRIPTION OF THE DRAWINGS

FIG. 1 is a perspective view of an interface card according to a preferred embodiment of the present invention;

FIG. 2 is a block diagram which shows the structure of the interface card according to a preferred embodiment of the present invention;

FIG. 3 shows an example of mounting components on the interface card according to preferred embodiments of the present invention;

FIGS. 4a and 4b are a plan view and a side view of an interface card for a media card according to a preferred embodiment of the present invention;

FIGS. 5a and 5b are a plan view and a side view of an interface card for a media card of another preferred embodiment of the present invention;

FIGS. 6a and 6b are a plan view and a side view of an interface card for a media card of still another preferred embodiment of the present invention;

FIGS. 7a, 7b, 7c and 7d are side views and a plan view of an interface card according to a preferred embodiment of the present invention which is capable of accepting a plurality of kinds of media cards which have different specifications; and

FIG. 8 is a block diagram of a conventional interface card.

### DETAILED DESCRIPTION OF THE PREFERRED EMBODIMENTS

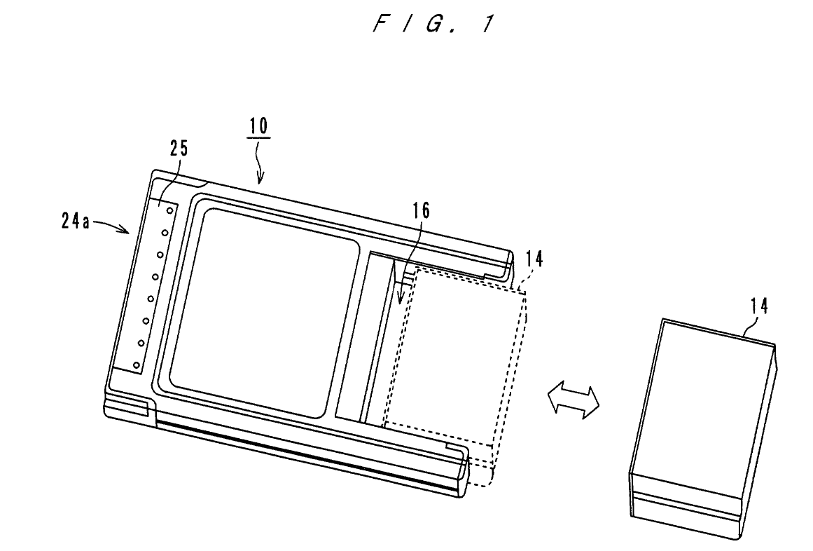

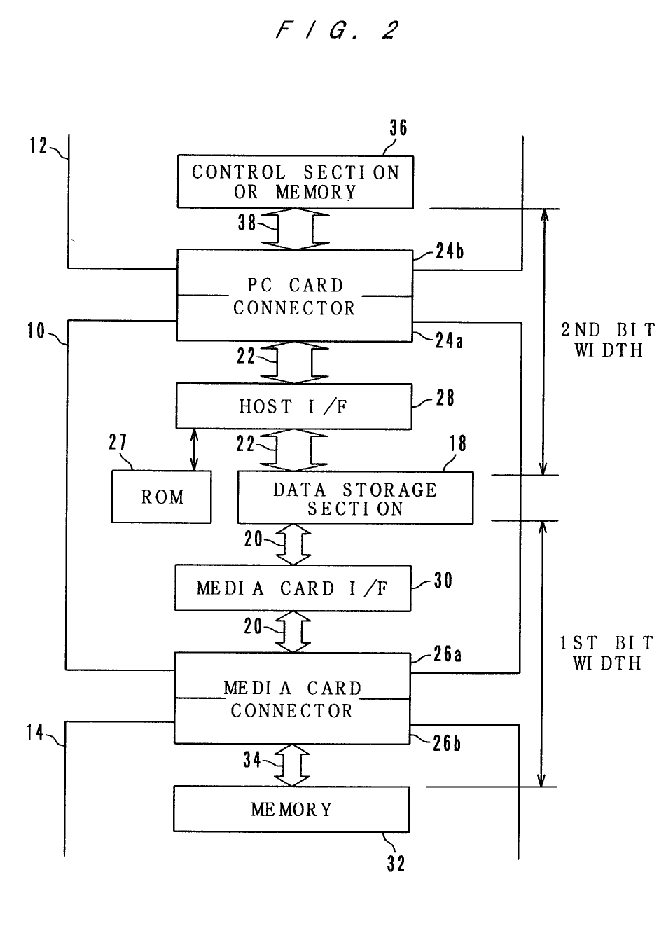

In the following, preferred embodiments of the present invention will be described with reference to the accompanying drawings. FIG. 1 is a perspective view of an interface card 10 according to a preferred embodiment of the present invention. FIG. 2 is a block diagram of the interface card. FIG. 3 shows an example of mounting components on the interface card 10.

As FIG. 1 shows, the interface card 10 is a card type adapter which permits data transmission between an information processing device (for example, a personal computer) and a media card 14. The interface card 10 permits the information processing device to read data from the media card 14 and to write data into the media card 14. The interface card 10 has a mounting port 16 in which a media card 14 can be fitted, and the interface card 10 can be inserted in a PC card slot while holding the media card 14 in the mounting port 16. The media card 14 may be a small storage medium (a memory card) or a small I/O card, such as a compact flash (a registered trademark), an SD (a registered trademark) memory card, a multimedia card (a registered trademark), a smart media (a registered trademark), a memory stick (a registered trademark), a small PC card (a registered trademark), or other suitable type card.

As FIG. 2 shows, the interface card 10 carries out data 10 transmission with the media card 14 via a data bus with a fist bit width (for example, 16-bit width) and carries out data transmission with the information processing device 12 via a data bus with a larger bit width (for example, 32-bit width). For the conversion of bit width, the interface card 10 has a data storage section 18 (for example, a memory buffer, a data register or other suitable device). The data storage section 18 is connected to a first data bus 20 with the first bit width and to a second data bus 22 with the second bit width. The data storage section 18 is capable of temporarily storing data to be sent from the media card 14 to the information processing device 12 and data to be sent from the information processing device 12 to the media card 14. The data storage section 18 has a number of storing regions which corresponds to at least the number of bits of the second bit width (for example, 32 bits), so that the number of bits of data can be stored simultaneously. The interface card 10 and the information processing device 12 are connected to each other via PC card connectors 24a and 24b, and the interface card 10 and the media card 14 are connected to each other via media card connectors 26a and 26b. Further, a host interface 28 is provided between the data storage section 18 and the PC card connector 24a, and a media card interface 30 is provided between the data storage section 18 and the media card connector 26a. In addition, the interface card 10 has a ROM 27 which stores its type, its ID, and other suitable information or data.

In the interface card 10 of this structure, when data are sent from the media card 14 to the information processing device 12, the data storage section 18 receives data from the first data bus 20 and stores the data therein until the storage section 18 stores a number of bits of data corresponding to the second bit width. For example, if the first bit width and the second bit width are 16 bits wide and 32 bits wide respectively, the data storage section 18 stores two times of synchronously transmitted data, that is, 32 bits of data (16 bits×2). The data storing regions for 32 bits of data of the data storage section 18 are connected to the respective lines of the second data bus 22 so that one data storing region is connected to one line of the second data bus 22. After 32 bits of data are stored in the data storing regions, the stored data are sent therefrom via the second data bus 22 with a 32-bit width.

When data are sent from the information processing device 12 to the media card 14, the data storage section 18 receives data from the second data bus 22 and stores the data. Then, the data storage section 18 divides the data into a plurality of blocks which are to be sent separately at a plurality of times and sends each block of data via the first data bus 20. For example, if the first bit width and the second bit width are 16 bits wide and 32 bits wide, respectively, the data storage section 18 stores one time of synchronously transmitted data, that is, 32 bits of data. Then, first, the former half (16 bits) of the data are sent via the first data bus 20, and next, the remaining half (16 bits) of the data are sent via the first data bus 20.

In the above-described structure, even if data transmission between the interface card 10 and the media card 14 (its memory 32) is carried out via a data bus 34 with the first bit width (for example, 16-bit width), data transmission between the information processing device 12 (its control section or memory 36, etc.) and the interface card 10 can be carried out via a data bus 38 with the second bit width (for example, by a card bus mode of a 32-bit width) which is larger than the first bit width. The control section 36 of the information processing device 12 recognizes from a signal sent via a control terminal (not shown) of the PC card connector 24a that data transmission via a data bus with the second bit width is possible and controls the respective sections so that data transmission to the PC card connector 24b can be carried out via the data bus 38 with the second bit width.

The improvement in data transmission rate by the interface card 10 according to preferred embodiments of the present invention is achieved when the rate of data transmission between the media card 14 and the data storage section 18 is higher than the rate of data transmission inside the information processing device 12. This is described in the following by referring to a specific example. If the first bit width and the second bit width are 16 bits wide and 32 bits wide, respectively and if the minimum interval among data transmissions inside the information processing device 12 is Δtp, when a conventional interface card which transmits data only via buses with a 16-bit width is used, it takes 2 Δtp to transmit 32 bits of data.

On the other hand, if the data transmission interval Δtc of the media card 14 is shorter than the data transmission interval Δtp inside the information processing device 12, that is, if Δtc<Δtp, with the interface card 10 according to preferred embodiments of the present invention which transmits data also via data buses with a 32-bit width, 32 bits of data are stored in the data storage section 18 and sent therefrom for a time 2 Δtc, which is shorter than 2 Δtp, although to be more exact, a very small amount of additional time is necessary from the storing of the data to the sending of the data. Thus, a shorter data transmission interval 2 Δtc which is shorter than a conventional 10 data transmission interval 2 Δtp can be achieved. Usually, the rate of data transmission between the media card 14 and the interface card 10 is higher than the rate of data transmission inside the information processing device 12.

The data storage section 18 can be constructed to be controlled 15 directly by a CPU (not shown) of the information processing device 12. In this case, the CPU monitors the data storage section 18, for example, at regular intervals, and when the CPU finds that data of the second bit width have been stored, the CPU controls the data storage section 18 to send the data therefrom to the information processing device 12 or the media card 14 immediately.

A structure is possible to permit a bus master (not shown) of the interface card 10 to control data transmission from the data storage section 18, so that direct data transmission between the memory 36 of the information processing device 12 and the data storage section 18 without a CPU in-between is possible. In this case, the data storage section 18 is monitored and controlled by the bus master.

Also, a structure is possible to permit data transmission between the data storage section 18 and the media card 14 and data transmission between the data storage section 18 and the information processing device 12 to be controlled independently of each other. In this case, the media card 14 preferably includes, for example, a first data transmission control section (for example, provided in the media card I/F; not shown) for controlling data transmission between the data storage section 18 and the media card 14, and a second data transmission control section (for example, provided in the host I/F; not shown) for controlling data transmission between the data storage section 18 and the information processing device 12. In this case, also, the second data transmission control section can be structured as a bus master so that direct data transmission between the memory 36 of the information processing device 12 and the data storage section 18 will be possible not depending on the CPU of the information processing device 12. Also, the data storage section 18 can be constructed to be capable of storing data of more than the second bit width. In this case, the second data transmission control section does not need monitor the number of bits of data stored in the data storage section 18, and at a specified data transmission time, if data of the second bit width or more exist in the data storage section 18, the data are sent to the information processing device 12 via the data buses with the second bit width.

The circuit of the interface card 10 which achieves the above-described operation is mounted in the way shown by FIG. 3. A printed board 42 with components 40 such as a data storage section 18, a ROM 27, etc. mounted thereon is fixed on a frame 44. Then, the frame 44 is bonded to two metal covers (not shown) on the upper surface and on the lower surface of the printed board 42. In this way, an interface card 10 as shown by FIG. 1 is structured. Further, as FIG. 1 shows, on the PC card connector 24a, a ground plate 25 in accordance with a card bus standard of a PC card standard is mounted. This ground plate 25 has eight convexities and is connected to a ground electrode (GND) of the printed board 42 in the vicinity of the PC card connector 24a.

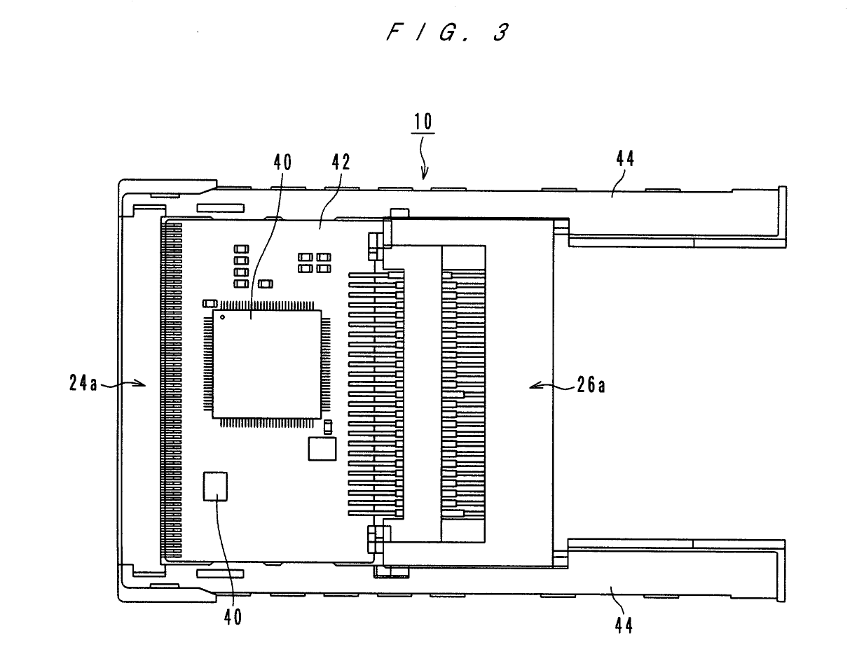

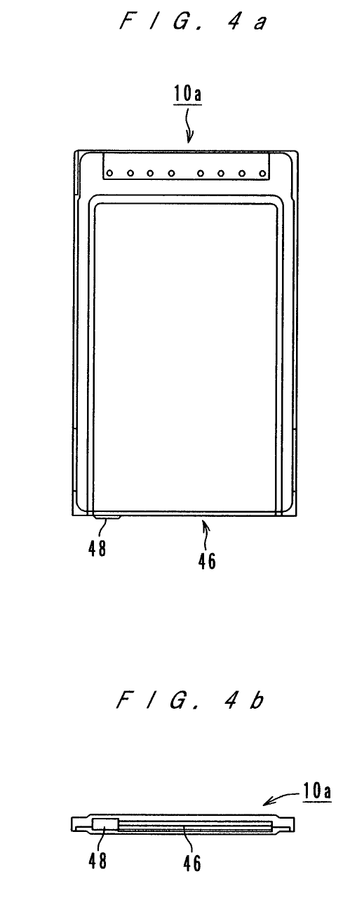

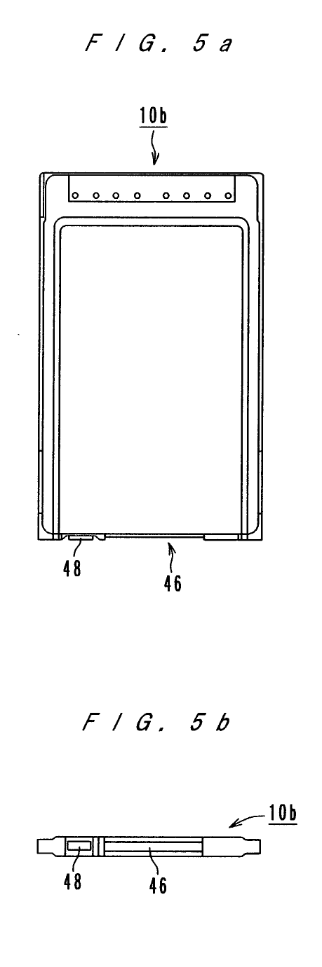

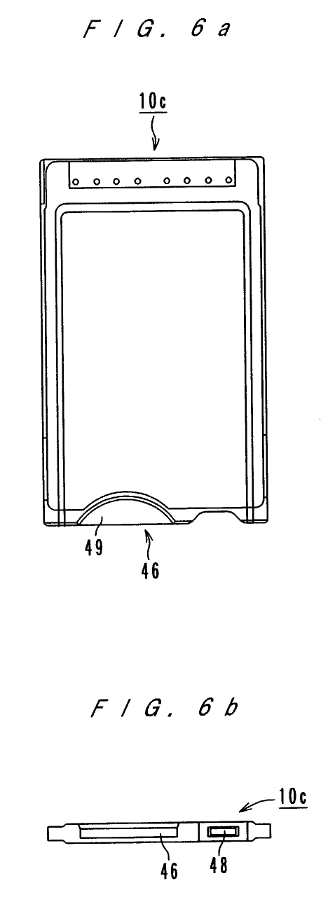

Next, insertion and ejection of a media card 14 into and from the interface card 10 are described. FIGS. 4a and 4b show an interface card 10a for smart media (a registered trademark; SSFDC). FIGS. 5a and 5b show an interface card 10b for an SD (a registered trademark) card. FIGS. 6a and 6b show an interface card 10c for a memory stick (a registered trademark). FIGS. 4a, 5a and 6a are plan views of the interface cards 10a, 10b and 10c, and FIGS. 4b, 5b and 6b are side views of the interface cards 10a, 10b and 10c.

As FIGS. 4a through 6b show, each of the interface cards 10a, 10b and 10c has a push button 48 for ejection of a media card by a side of an opening 46 for insertion of a media card. Also, each of the interface cards 10a, 10b and 10c has a media card engaging device (not shown). The push button 48 and the media card engaging device mechanically operate together to eject a media card. Specifically, while a media card is held in the interface card 10a, when the button 48 is pushed in, by operation of a link mechanism (not shown), the media card engaging device releases and pushes out the media card through the opening 46. The interface card 10c shown by FIG. 6a has a cut-out 49 at an end of the opening 46, which makes the insertion and ejection (especially ejection) of a media card easier.

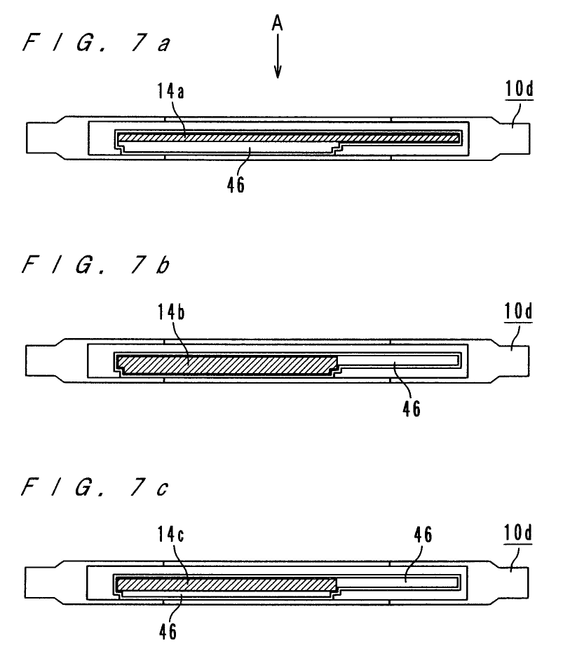

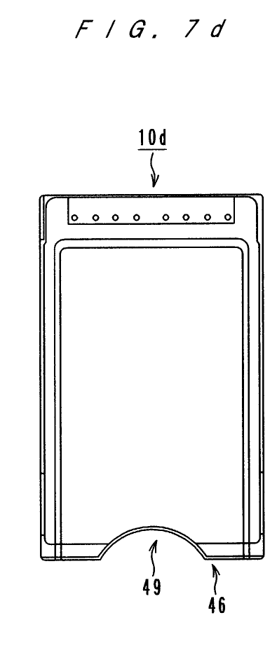

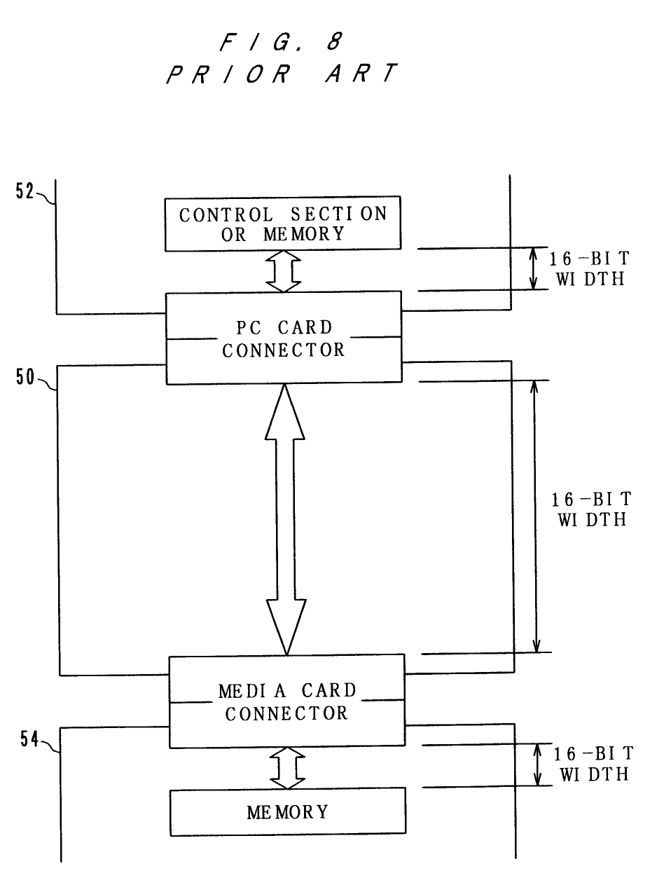

Also, the interface card 10 can be constructed so as to accept a plurality of kinds of media cards which are different from each other in various specifications (for example, size, shape, positions of connector pins, etc.). FIGS. 7a, 7b and 7c are side views of an interface card 10d viewed from the opening 46, and the interface card 10d is capable of accepting a smart media (a registered trademark; SSFDC) 14a, an SD (a registered trademark) card 14b and a memory stick (a registered trademark) 14c. FIG. 7a shows a state in which the wider media card 14a is inserted; FIG. 7b shows a state in which the narrower media card 14b is inserted; FIG. 7c shows a state in which the media card 14c having almost the same width as the media card 14b does but having a different specification is inserted; and FIG. 7d is a plan view of the interface card 10d viewed from the direction A shown in FIG. 7a. This interface card 10d has three connectors (not shown) for a media card 14a, for a media card 14b and for a media card 14c which are arranged in parallel three steps from the front side (upper sides in FIGS. 7a, 7b and 7c) to the back side (lower sides in FIGS. 7a, 7b and 7c) in this order. The media cards 14a, 14b and 14c are held in the interface card 10d in the respective positions shown by FIGS. 7a, 7b and 7c. Also, as FIG. 7d shows, this interface card 10d has a cut-out 49 as the interface card 10c shown by FIG. 6a does, and thereby, insertion and ejection of the media cards 14a, 14b and 14c are easy.

Although preferred embodiments of the present invention have been described above, the present invention is not limited to the above-described preferred embodiments. For example, the first bit width and the second bit width are not necessarily 16 bits wide and 32 bits wide respectively, and the present invention is applicable to other specifications. Also, the first data bus may be a serial bus (port). Further, in this specification, a bus means a communication line which carries out parallel data transmission via conductors and includes various kinds.

Although the present invention has been described in connection with the preferred embodiments, it is to be noted that various changes and modifications are possible to those who are skilled in the art. Such changes and modifications are to be understood as being within the present invention.

As described above, an interface card according to preferred embodiments of the present invention permits data transmission with an information processing device by a mode using a data bus with a bit width which is larger than the conventional method, so that the respective data processing abilities of the information processing device and the media card can be fully used, thereby resulting in an increase in data transmission speed.

What is claimed is:

1. An interface card for a media card which is capable of being inserted into and ejected from a card slot of an information processing device while holding a media card therein and which carries out data transmission between the media card and the information processing device, said interface card comprising:
a data storage section which is capable of storing data sent from the media card;
wherein a mode which is adopted for data transmission between the data storage section and the information processing device and a mode which is adopted for data transmission between the data storage section and the media card are different from each other.

2. An interface card for a media card according to claim 1, further comprising a first data bus and a second data bus, wherein:
data transmission between the media card and the data storage section is carried out via the first data bus with a first bit width; and
data transmission between the information processing device and the data storage section is carried out via the second data bus with a second bit width.

3. An interface card for a media card according to claim 2, wherein the first bit width is 16 bits wide, and the second bit width is 32 bits wide.

4. An interface card according to claim 1, wherein data transmission between the media card and the data storage section is carried out via a serial bus.

5. An interface card according to claim 1, further comprising:
a first data transmission control section for controlling data transmission between the media card and the data storage section; and
a second data transmission control section for controlling data transmission between the data storage section and the information processing device,
wherein the first data transmission control section and the second data transmission control section carry out data transmission control independently of each other.

6. An interface card for a media card according to claim 1, further comprising a connector which permits the interface card to accept different kinds of media cards.

7. An interface card for a media card according to claim 1, further comprising a mounting port that is constructed to hold one of a memory card, a compact flash, a SD memory card, a multimedia card, a smart media, a memory stick, and a small PC card.

8. An interface card for a media card according to claim 1, wherein the data storage section includes a plurality of storing regions which corresponds to at least the number of bits of the second bit width so that the number of bits of data can be stored simultaneously.

9. An interface card for a media card according to claim 1, wherein the data storage section is arranged to be controlled directly by a CPU of the information processing device.

10. An interface card for a media card according to claim 1, wherein the data storage section is constructed to store more data than the number of bits of the second bit width.
